(19) United States
(12) Patent Application Publication
(10) Pub. No.: US 2024/0271901 A1
(43) Pub. Date: Aug. 15, 2024

(54) Composite Limb

(71) Applicant: MCP IP, LLC, Sparta, WI (US)

(72) Inventor: Mathew A. McPherson, Norwalk, WI (US)

(73) Assignee: MCP IP, LLC, Sparta, WI (US)

(21) Appl. No.: 18/438,311

(22) Filed: Feb. 9, 2024

Related U.S. Application Data
(60) Provisional application No. 63/444,857, filed on Feb. 10, 2023.

(51) Int. Cl. F41B 5/14; B32B 3/26; B32B 5/12; B32B 7/022; B32B 37/18

(52) U.S. Cl. CPC F41B 5/1403; B32B 3/263; B32B 5/12; B32B 7/022; B32B 37/18; B32B 2260/023; B32B 2260/046; B32B 2305/076; B32B 2307/54

(57) ABSTRACT

In some embodiments, an archery bow limb comprises a body comprising a tension surface, a compression surface, a first layer and a second layer. The first layer comprises the compression surface and comprises first reinforcing fibers. The second layer comprises the tension surface and comprises second reinforcing fibers. The first reinforcing fibers are oriented at a non-zero angle to the second reinforcing fibers.

### CROSS-REFERENCE TO RELATED APPLICATIONS

This application claims the benefit of U.S. Patent Application No. 63/444,857, filed Feb. 10, 2023, the entire content of which is hereby incorporated herein by reference.

### BACKGROUND OF THE INVENTION

This invention relates generally to composite materials and more specifically to composite flexural members and methods of making composite flexural members.

Composite materials often include a matrix material and reinforcing fibers. The matrix material, often a polymer, binds the reinforcing fibers together and transfers loads between them, while the reinforcing fibers provide the composite with mechanical strength and stiffness. Reinforcing fibers can be made from a variety of materials, including glass and carbon.

There remains a need for advancements in composite material technology to provide flexural members that are strong, lightweight and exhibit longevity.

All US patents and applications and all other published documents mentioned anywhere in this application are incorporated herein by reference in their entirety.

Without limiting the scope of the invention a brief summary of some of the claimed embodiments of the invention is set forth below. Additional details of the summarized embodiments of the invention and/or additional embodiments of the invention may be found in the Detailed Description of the Invention below.

A brief abstract of the technical disclosure in the specification is provided as well only for the purposes of complying with 37 C.F.R. 1.72. The abstract is not intended to be used for interpreting the scope of the claims

### SUMMARY OF THE INVENTION

In some embodiments, a device comprises a body comprising a first layer and a second layer. The first layer comprises a first composite material comprising first reinforcing fibers and the second layer comprises a second composite material comprising second reinforcing fibers. The first reinforcing fibers are oriented at a non-zero angle to the second reinforcing fibers.

In some embodiments, the non-zero angle is between 1 and 2 degrees.

In some embodiments, the second reinforcing fibers are different from the first reinforcing fibers.

In some embodiments, a tensile strength of the second reinforcing fibers is greater than a tensile strength of the first reinforcing fibers.

In some embodiments, the first reinforcing fibers comprise unidirectional reinforcing fibers.

In some embodiments, the first reinforcing fibers extend along a length of the device.

In some embodiments, the second reinforcing fibers extend a full length of the device.

In some embodiments, at least some of the first reinforcing fibers have a length that is less than a length of the second reinforcing fibers.

In some embodiments, an archery bow limb comprises a body comprising a tension surface, a compression surface, a first layer and a second layer. The first layer comprises the compression surface and comprises first reinforcing fibers. The second layer comprises the tension surface and comprises second reinforcing fibers. The first reinforcing fibers are oriented at a non-zero angle to the second reinforcing fibers.

In some embodiments, the non-zero angle is between 1 and 2 degrees.

In some embodiments, the second reinforcing fibers extend a full length of the archery bow limb.

In some embodiments, the compression surface comprises a planar portion and a non-planar portion, and the first reinforcing fibers are oriented parallel to the planar portion.

In some embodiments, the second reinforcing fibers are oriented parallel to the tension surface.

In some embodiments, a method comprises providing a bar stock comprising a body comprising first reinforcing fibers, the body comprising a surface oriented nonparallel to said first reinforcing fibers. The method comprises applying a cover layer of composite material to said surface, the cover layer comprising second reinforcing fibers, the second reinforcing fibers oriented nonparallel to said first reinforcing fibers. In some embodiments, the first reinforcing fibers comprise first unidirectional fibers and the second reinforcing fibers comprise second unidirectional fibers.

In some embodiments, the cover layer comprises a tension surface and the method further comprises removing material from the bar stock to form a compression surface.

In some embodiments, the compression surface comprising a planar portion and a portion comprising curvature. In some embodiments, the planar portion is parallel to the first reinforcing fibers.

In some embodiments, providing the bar stock comprises providing a workpiece and removing material from the workpiece to form the surface oriented nonparallel to the first reinforcing fibers.

In some embodiments, applying a cover layer comprises attaching the cover layer to the body with an adhesive.

In some embodiments, a method comprises providing an archery bow limb precursor comprising a body comprising first reinforcing fibers and a cover layer comprising second reinforcing fibers, the second reinforcing fibers oriented nonparallel to said first reinforcing fibers, and removing material from the body.

These and other embodiments which characterize the invention are pointed out with particularity in the claims annexed hereto and forming a part hereof. However, for a better understanding of the invention, its advantages and objectives obtained by its use, reference can be made to the drawings which form a further part hereof and the accompanying descriptive matter, in which there are illustrated and described various embodiments of the invention.

### BRIEF DESCRIPTION OF DRAWINGS

A detailed description of the invention is hereafter described with specific reference being made to the drawings.

FIG. 1 shows an embodiment of a composite material.

FIG. 2 shows another embodiment of a composite material.

FIG. 3 shows another embodiment of a composite material.

FIGS. 4 and 5 show embodiments of a limb profile on a composite material workpiece.

FIG. 6 shows an embodiment of a limb.

FIG. 7 shows an embodiment of a limb and a support.

FIG. 8 shows a cross-sectional view of the limb and support shown in FIG. 7.

### DETAILED DESCRIPTION OF THE INVENTION

While this invention may be embodied in many different forms, there are described in detail herein specific embodiments of the invention. This description is an exemplification of the principles of the invention and is not intended to limit the invention to the particular embodiments illustrated.

For the purposes of this disclosure, like reference numerals in the figures shall refer to like features unless otherwise indicated.

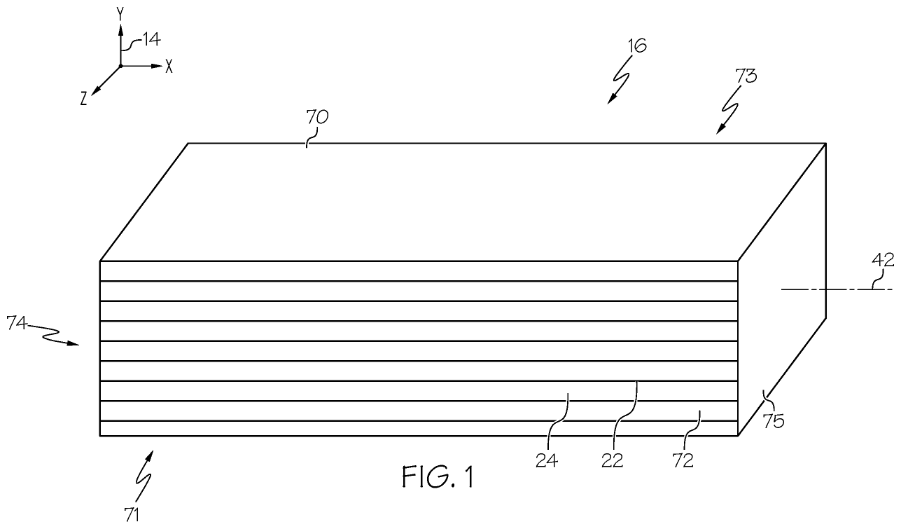

FIG. 1 shows an embodiment of a bar stock 16 of composite material. In some embodiments, a bar stock 16 comprises a workpiece suitable for forming devices such as flexural members, springs, limbs, etc.

In some embodiments, a bar stock 16 comprises a top 70 oriented parallel to a bottom 71. In some embodiments, the bar stock 16 comprises a first side 72 oriented parallel to a second side 73. In some embodiments, the bar stock 16 comprises a first end 74 oriented parallel to a second end 75. In some embodiments, the outer surfaces of the bar stock 16 are planar.

In some embodiments, a composite material comprises a plurality of reinforcing fibers 22 oriented in a body material 24. In some embodiments, the body material 24 comprises a filler material. In various embodiments, any suitable reinforcing fibers 22 can be used with any suitable body material 24. In some embodiments, reinforcing fibers 22 comprise glass fibers. In some embodiments, reinforcing fibers 22 comprise carbon fibers. In some embodiments, the body material 24 comprises a polymeric material, an epoxy, a resin, a thermoplastic material, a thermoset material, etc. A composite material can be made using any suitable method. In some embodiments, the reinforcing fibers 22 are pretensioned and the composite material is molded under heat and pressure.

In some embodiments, a composite material can comprise any suitable amount of reinforcing fibers 22 as compared to the body material 24. In some embodiments, the reinforcing fibers 22 comprise 20%-60% by weight of the composite material. In some embodiments, the reinforcing fibers 22 comprise 30%-40% by weight of the composite material.

In some embodiments, the reinforcing fibers 22 in a bar stock 16 are oriented parallel to one another. In some embodiments, the reinforcing fibers 22 comprise unidirectional fibers. In some embodiments, the reinforcing fibers 22 are continuous and extend an entire length of the bar stock 16. In some embodiments, the reinforcing fibers 22 extend parallel to a longitudinal axis 42 of the bar stock 16. In some embodiments, the reinforcing fibers 22 extend parallel to a side surface 72, 73 of the bar stock 16. In some embodiments, the reinforcing fibers 22 extend parallel to a top surface 70 of the bar stock 16. In some embodiments, the reinforcing fibers 22 extend parallel to a bottom surface 71 of the bar stock 16. In some embodiments, the reinforcing fibers 22 extend orthogonal to an end surface 74, 75 of the bar stock 16.

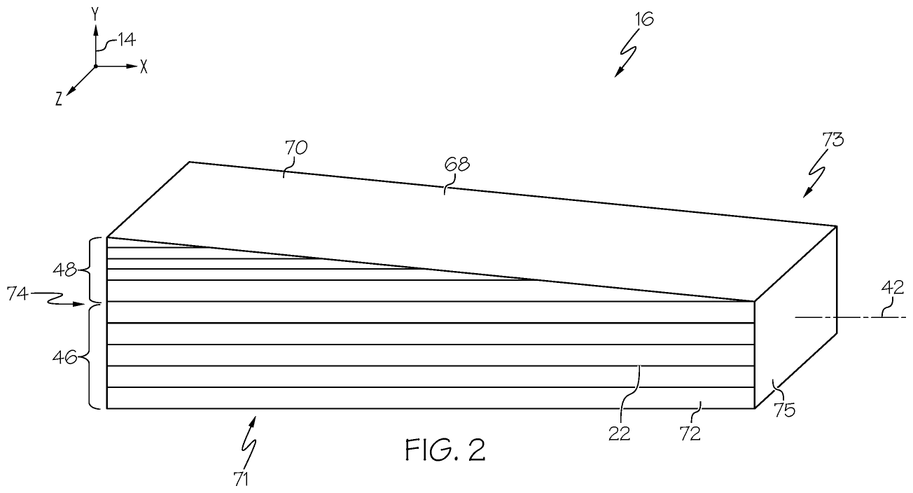

FIG. 2 shows another embodiment of a bar stock 16. In some embodiments, a bar stock 16 comprises a surface 68 that is oriented non-orthogonal to at least one adjacent surface. In some embodiments, a bar stock 16 comprises a surface 68 that is oriented non-orthogonal to a plurality of adjacent surfaces. For example, FIG. 2 shows a bar stock 16 comprising a top 70 surface that is planar and oriented at a non-orthogonal angle to a first side surface 72, a second side surface 73, a first end surface 74 and a second end surface 75. In some embodiments, a top 70 surface of a bar stock 16 is non-parallel to a bottom 71 surface. In some embodiments, a bar stock 16 comprises a surface 68 that is oriented nonparallel to the longitudinal axis 42. in some embodiments, a bar stock 16 comprises a surface 68 that is oriented nonparallel to reinforcing fibers 22.

A bar stock 16 as shown in FIG. 2 can be made using any suitable method. In some embodiments, a bar stock 16 can be molded, laminated or otherwise manufactured to have a desired shape.

In some embodiments, material can be removed from a bar stock 16 to achieve a desired shape, such as a non-orthogonal surface 68. In some embodiments, a bar stock 16 as shown in FIG. 1 is provided, for example comprising a cuboid or comprising orthogonal outer surfaces. In some embodiments, material is removed to form a bar stock 16 as shown in FIG. 2. Any suitable method can be used for removing material, such as machining, cutting, water-jet cutting, grinding, sanding, etc.

In some embodiments, a reference coordinate system 14 defines orthogonal X, Y and Z axes. In some embodiments, a longitudinal axis 42 of the bar stock 16 is oriented parallel to the X-axis. In some embodiments, a first side 72 and a second side 73 are oriented parallel to an X-Y plane. In some embodiments, a first end 74 and a second end 75 are oriented parallel to a Y-Z plane. In some embodiments, a bottom 71 surface is oriented parallel to an X-Z plane. In some embodiments, a top 70 surface comprises a non-orthogonal surface 68 that is oriented non-parallel to the bottom 71 surface. In some embodiments, a top 70 surface is oriented at a non-zero angle to the X-Z plane. In some embodiments, the angle can range from greater than zero to any suitable angle. In some embodiments, the angle can range from 0.1 degrees to greater than 45 degrees. In some embodiments, for example in some flexural members, the angle can range from 0.1 degrees to 5 degrees. In some embodiments, the angle ranges from 0.5 degrees to 3 degrees. In some embodiments, the angle ranges from 1 degree to 2 degrees. In some embodiments, the angle is approximately 1.7 degrees.

In some embodiments, reinforcing fibers 22 extend parallel to the X-axis. In some embodiments, the non-orthogonal surface 68 is oriented at a non-zero angle to the reinforcing fibers 22. In some embodiments, the bar stock 16 comprises a first section 46 and a second section 48. In some embodiments, reinforcing fibers 22 in the first section 46 are continuous and unidirectional and comprise a predetermined length, such as a length of the bar stock 16. In some embodiments, reinforcing fibers 22 in the second section 48 are continuous and unidirectional, and have a shorter length than reinforcing fibers 22 in the first section 46.

In some embodiments, the non-orthogonal surface 68 comprises exposed portions of the reinforcing fibers 22. In some embodiments, the non-orthogonal surface 68 comprises exposed ends of the reinforcing fibers 22. In some embodiments, the end surfaces 74, 75 of a bar stock 16 comprise exposed ends of the reinforcing fibers 22. In some embodiments, the sides 72, 73 of a bar stock 16 do not include any exposed reinforcing fibers 22. In some embodiments, the bottom 71 does not include any exposed reinforcing fibers 22.

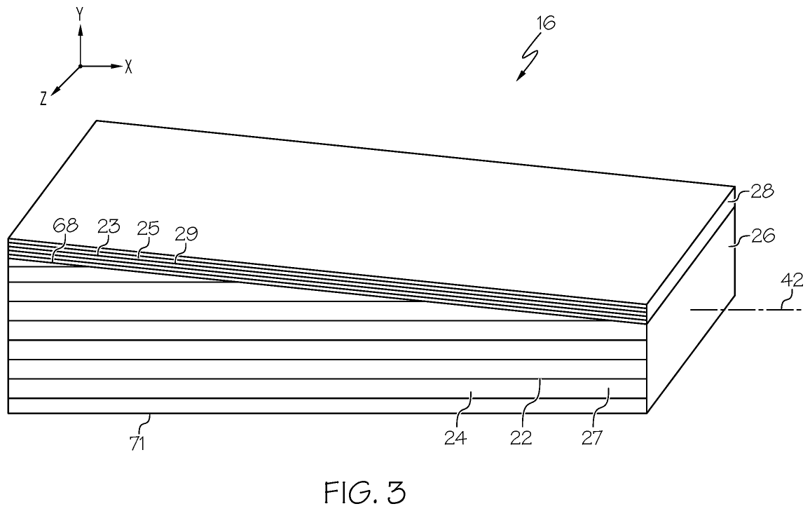

FIG. 3 shows another embodiment of a bar stock 16. In some embodiments, a bar stock 16 comprises a first portion 26 and a second portion 28, wherein the second portion 28 is oriented differently from the first portion 26. In some embodiments, the first portion 26 comprises an embodiment of a bar stock 16 as shown in FIG. 2. In some embodiments, the second portion 28 comprises a cover layer arranged to cover the non-orthogonal surface 68 of the first portion 26. In some embodiments, the second portion 28 is attached to the first portion 26 with an adhesive. In some embodiments, the reinforcing fibers 22 of the first portion 26 consists of unidirectional fibers.

In some embodiments, the first portion 26 and second portion 28 comprise similar materials, for example comprising similar composite materials. In some embodiments, the first portion 26 generally is oriented at a non-zero angle to the second portion 28. In some embodiments, reinforcement fibers 22 of the first portion are oriented at a non-zero angle to reinforcement fibers 22 of the second portion 28.

In some embodiments, a surface 68 of the first portion 26 that contacts the second portion 28 comprises end portions of reinforcing fibers 22. In some embodiments, a surface of the second portion 28 that contacts the first portion 26 does not comprise any exposed ends of the reinforcing fibers 22.

In some embodiments, reinforcing fibers 22 of the second portion 28 comprise unidirectional reinforcing fibers extending parallel to one another. In some embodiments, reinforcing fibers 22 of the second portion 28 comprise a weave pattern that includes some fibers oriented in a first predetermined direction and other fibers oriented in a second predetermined direction, for example at right angles to one another. In some embodiments, the top surface and lateral side surfaces of the second portion 28 do not include any exposed ends of reinforcing fibers 22.

In some embodiments, the first portion 26 comprises a first material 27 and the second portion 28 comprises a second material 29. In some embodiments, the first material 27 is different from the second material 29. In some embodiments, the first portion 26 comprises a composite material comprising a first body material 24 and first reinforcing fibers 22. In some embodiments, the second portion 28 comprises a second composite material comprising a second body material 25 and second reinforcing fibers 23. In some embodiments, the first reinforcing fibers 22 are different from the second reinforcing fibers 23. In some embodiments, the second reinforcing fibers 23 have a higher tensile strength than the first reinforcing fibers 22. In some embodiments, the first material 27 comprises an E-glass fiberglass composite material and the second material 29 comprises an S-glass fiberglass composite material.

In some embodiments, a workpiece is provided comprising a bar stock 16 as shown in FIG. 3. In some embodiments, the workpiece is machined to change its shape and achieve a desired profile. In some embodiments, material is removed from the first portion 26. In some embodiments, material is removed from the bottom surface 71.

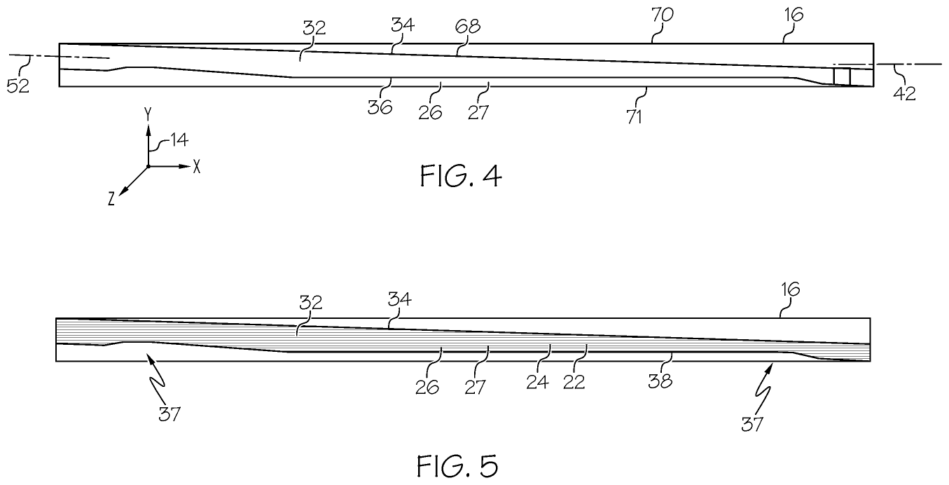

FIGS. 4 and 5 show an embodiment of a limb 32 that can be formed by removing material from an embodiment of a bar stock 16. In some embodiments, the reinforcing fibers 22 of the bar stock 16 extend parallel to a longitudinal axis 42 of the bar stock 16. In some embodiments, the limb 32 is oriented having a longitudinal axis 52 non-parallel to the longitudinal axis 42 of the bar stock 16.

In some embodiments, a first or tension surface 34 of the limb 32 is formed by removing material from the top 70 of the bar stock 16. In some embodiments, the tension surface 34 of the limb 32 is planar. In some embodiments, the longitudinal axis 52 of the limb 32 extends parallel to the tension surface 34. In some embodiments, the reinforcing fibers 22 extend non-parallel to the tension surface 34 of the limb 32. In some embodiments, the tension surface 34 of the limb 32 comprises a non-orthogonal surface 68 as described herein, and can comprise exposed portions of reinforcing fibers 22.

In some embodiments, the limb 32 comprises a compression surface 36. In some embodiments, the compression surface 36 is formed by removing material from the bottom 71 of the bar stock 16. In some embodiments, the compression surface 36 comprises a straight portion 38 extending along the length of the limb 32. In some embodiments, the compression surface 36 further comprises one or more contoured portions 37 that comprise curvature or a non-linear portion. In some embodiments, the straight portion 38 comprises a planar surface.

In some embodiments, the straight portion 38 of the compression surface 36 is used to orient the limb 32 with respect to the bar stock 16. In some embodiments, the straight portion 38 comprises the longest continuous straight portion of the compression surface 36. In some embodiments, the straight portion 38 is oriented parallel to the reinforcing fibers 22 of the bar stock 16. Thus, in some embodiments, the straight portion 38 of the compression surface will exclude any exposed reinforcing fibers 22. In some embodiments, the contoured portion(s) 37 of the compression surface 36 are oriented non-parallel to the straight portion 38, and the contoured portion(s) 37 can include exposed portions of reinforcing fibers 22.

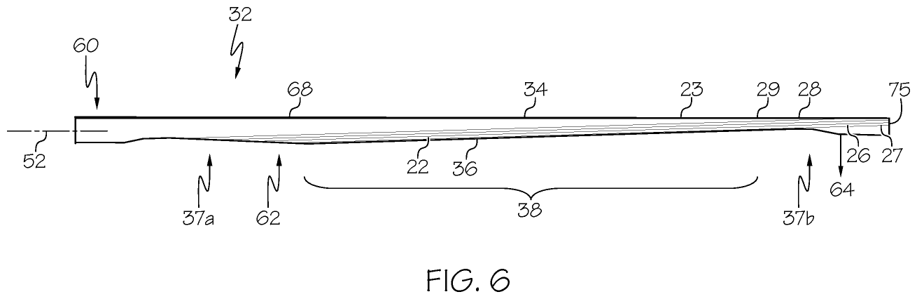

FIG. 6 shows another embodiment of a limb 32. In some embodiments, a limb 32 comprises a first portion 26 comprising a first material 27 as described herein and a second portion 28 comprising a second material 29. In some embodiments, the first material 27 comprises an E-glass composite material and the second material 29 comprises an S-glass composite material. In some embodiments, the second portion 28 comprises a laminate coating of a stronger composite material attached to the first portion 26. In some embodiments, an upper surface of the first portion 26 comprises a non-orthogonal surface 68 comprising exposed portions of first reinforcing fibers 22. In some embodiments, the second portion 28 comprises a cover layer arranged to cover any portions of exposed first reinforcing fibers 22. In some embodiments, the second reinforcing fibers 23 of the second material 29 extend parallel to the tension surface 34 of the limb 32.

In some embodiments, the compression surface 36 of the limb 32 comprises a straight portion 38. In some embodiments, the first reinforcing fibers 22 extend parallel to the straight portion 38 and non-parallel to the longitudinal axis 52 of the limb 32. In some embodiments, the compression surface 36 can further comprise one or more contoured portion(s) 37. In some embodiments, a limb 32 comprises a first contoured portion 37a located to a first side of the straight portion 38 and a second contoured portion 37b located to a second side of the straight portion 38. In some embodiments, the straight portion 38 is located in a middle portion of the limb 32.

In some embodiments, a limb 32 is supported at a first end 74 by a moment connection to a support. In some embodiments, the supporting force comprises a force couple comprising a first force 60 applied to the tension surface 34 and a second force 62 applied to the compression surface 36. In some embodiments, the limb 32 supports a load 64 applied at the second end 75. In some embodiments, a load 64 can be provided by a bowstring, an axle, a rotatable member, etc.

In some embodiments, the straight portion 38 of the compression surface 36 is oriented between a location of the second force 62 and a location of the load 64. In some embodiments, the straight portion 38 extends from the location of the second force 62 in a direction toward the location of the load 64.

The straight portion 38 of the compression surface 36 can extend any suitable portion of the length of the limb 32. In some embodiments, the straight portion 38 extends at least ¼ of the total length of the limb 32. In some embodiments, the straight portion 38 extends at least ½ of the total length of the limb 32. In some embodiments, the straight portion 38 extends at least 60% of the total length of the limb 32. In some embodiments, an unsupported length of the limb 32 comprises a length portion of the limb 32 located distal to the second force 62. In some embodiments, the straight portion 38 extends at least ½ of the unsupported length of the limb 32. In some embodiments, the straight portion 38 extends at least 60% of the unsupported length of the limb 32. In some embodiments, the straight portion 38 extends at least 70% of the unsupported length of the limb 32. In some embodiments, the straight portion 38 extends at least 80% of the unsupported length of the limb 32.

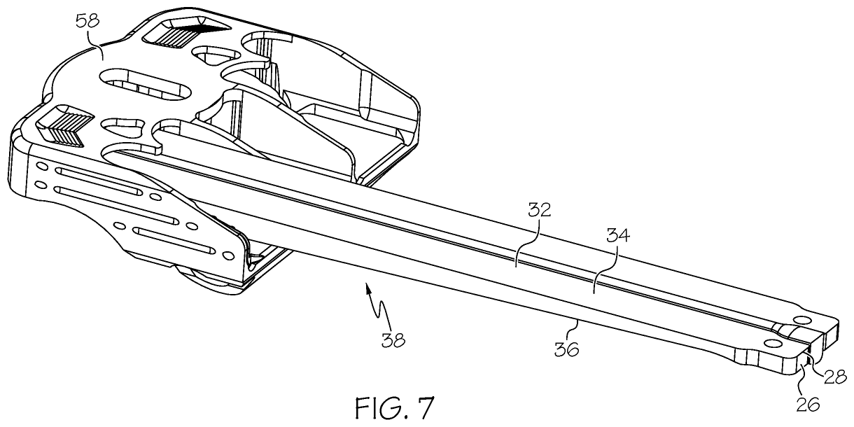

FIG. 7 shows an embodiment of a limb 32 with an embodiment of a support 58. In some embodiments, a support 58 comprises a limb cup.

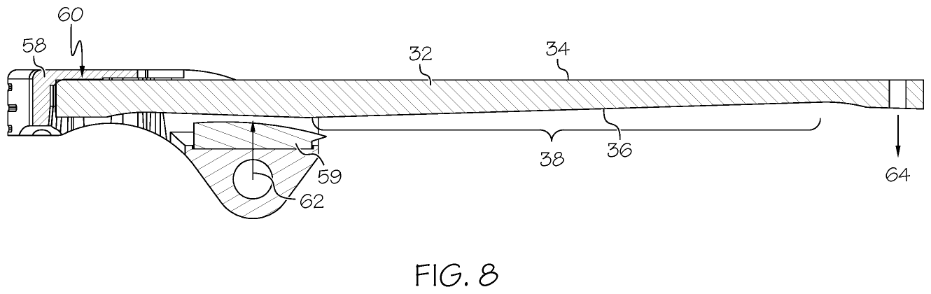

FIG. 8 shows a cross-sectional view of the limb 32 and support 58 shown in FIG. 7. In some embodiments, the second force 62 is provided by a limb pad 59. Although the limb 32 is shown in a non-loaded condition wherein a longitudinal axis is straight, a skilled person will recognize that when a load 64 is applied to the limb 32, the limb 32 can assume a stressed condition comprising curvature along its longitudinal axis. In some embodiments, the straight portion 38 of the compression surface 38 contacts the limb pad 59 during at least some orientations of an archery bow, such as a drawn condition.

In some embodiments, a method comprises providing a workpiece as shown in FIG. 3 and removing material from a bottom surface to form a limb.

In some cases, the method may include providing an archery bow limb precursor which includes a body with first reinforcing fibers and a cover layer. The cover layer may include second reinforcing fibers. The second reinforcing fibers may be oriented nonparallel to the first reinforcing fibers. The method may also include removing material from the body to form an archery bow limb.

The above disclosure is intended to be illustrative and not exhaustive. This description will suggest many variations and alternatives to one of ordinary skill in this field of art. All these alternatives and variations are intended to be included within the scope of the eventual claims where the term “comprising” means “including, but not limited to.” Those familiar with the art may recognize other equivalents to the specific embodiments described herein which equivalents are also intended to be encompassed by the claims.

This completes the description of the preferred and alternate embodiments of the invention. Those skilled in the art may recognize other equivalents to the specific embodiment described herein which equivalents are intended to be encompassed by the claims attached hereto.

1. A device comprising:
a body comprising a first layer and a second layer;
the first layer comprising a first composite material comprising first reinforcing fibers;
the second layer comprising a second composite material comprising second reinforcing fibers;
wherein the first reinforcing fibers are oriented at a non-zero angle to the second reinforcing fibers.

2. The device of claim 1, wherein the second reinforcing fibers are different from the first reinforcing fibers.

3. The device of claim 1, wherein a tensile strength of the second reinforcing fibers is greater than a tensile strength of the first reinforcing fibers.

4. The device of claim 1, wherein the first reinforcing fibers comprise unidirectional reinforcing fibers.

5. The device of claim 1, wherein the first reinforcing fibers extend along a length of the device.

6. The device of claim 1, wherein the second reinforcing fibers extend a full length of the device.

7. The device of claim 6, comprising first reinforcing fibers having a length that is less than a length of the second reinforcing fibers.

8. The archery bow limb of claim 1, wherein the non-zero angle is between 1 and 2 degrees.

9. An archery bow limb comprising:
a body comprising a tension surface and a compression surface, the body comprising a first layer and a second layer;
the first layer comprising first reinforcing fibers, the first layer comprising the compression surface;
the second layer comprising second reinforcing fibers, the second layer comprising the tension surface;
wherein the first reinforcing fibers are oriented at a non-zero angle to the second reinforcing fibers.

10. The archery bow limb of claim 9, wherein the second reinforcing fibers extend a full length of the archery bow limb.

11. The archery bow limb of claim 9, the compression surface comprising a planar portion and a non-planar portion, the first reinforcing fibers oriented parallel to the planar portion.

12. The archery bow limb of claim 9, wherein the non-zero angle is between 1 and 2 degrees.

13. The archery bow limb of claim 9, wherein the second reinforcing fibers are oriented parallel to the tension surface.

14. A method comprising:
providing a bar stock comprising a body comprising first reinforcing fibers, the body comprising a surface oriented nonparallel to said first reinforcing fibers; and
applying a cover layer of composite material to said surface, the cover layer comprising second reinforcing fibers, the second reinforcing fibers oriented nonparallel to said first reinforcing fibers.

15. The method of claim 14, wherein the first reinforcing fibers comprise first unidirectional fibers and the second reinforcing fibers comprise second unidirectional fibers.

16. The method of claim 14, wherein the cover layer comprises a tension surface, the method further comprising removing material from the bar stock to form a compression surface.

17. The method of claim 16, the compression surface comprising a planar portion and a portion comprising curvature.

18. The method of claim 17, wherein the planar portion is parallel to the first reinforcing fibers.

19. The method of claim 14, wherein said providing a bar stock comprises providing a workpiece and removing material from the workpiece to form said surface oriented nonparallel to said first reinforcing fibers.

20. The method of claim 14, wherein said applying a cover layer comprises attaching the cover layer to the body with an adhesive.
